(19) United States
(12) Patent Application Publication
(10) Pub. No.: US 2020/0195531 A1
(43) Pub. Date: Jun. 18, 2020

(54) ANALYTICS ON NETWORK SWITCH USING MULTI-THREADED SANDBOXING OF A SCRIPT

(71) Applicant: Hewlett Packard Enterprise Development LP, Houston, TX (US)

(72) Inventor: Anu Mercian, Santa Clara, CA (US)

(21) Appl. No.: 16/221,399

(22) Filed: Dec. 14, 2018

(51) Int. Cl. H04L 12/26; H04L 12/931; G06F 9/48; G06F 9/455; G06F 9/50

(52) U.S. Cl. CPC H04L 43/04; H04L 43/0817; H04L 49/70; G06F 2009/45595; G06F 9/45558; G06F 9/5083; G06F 9/4881

(57) ABSTRACT

A network switch may include a memory to store monitored switch data, at least one processing core to execute threads and a sandbox manager. The sandbox manager is to receive a network analytics script for analyzing the monitored switch data. The sandbox manager further performs multi-threaded sandboxing of the network analytics script by creating different sandboxes on different particular threads to execute different portions of the networks analytics script.

### BACKGROUND

Network switches route communications within a network. Performance of the switch and of the network may be monitored by each switch and stored as data. The data may be analyzed for troubleshooting or optimization.

### BRIEF DESCRIPTION OF THE DRAWINGS

FIG. 1 is a block diagram illustrating portions of an example network switch including an example sandbox manager.

FIG. 2 is a flow diagram of an example network switch analytics method.

FIG. 3 is a block diagram schematically illustrating portions of an example set of script sandboxing instructions.

FIG. 4 is a block diagram illustrating portions of an example network switch including an example sandbox manager having an example sandboxing scheduler.

FIG. 5 is a diagram illustrating an example of scheduling of sandboxes containing analytic scripts on different threads in an example network switch.

FIG. 6 is a flow diagram illustrating an example network analytic script sandbox scheduling method.

FIG. 7 is a block diagram schematically illustrating portions of an example sandbox manager.

FIG. 8 is a flow diagram of an example script sandboxing method for being carried out by the example sandbox manager of FIG. 7.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example network switches, methods and script sandboxing instructions that facilitate customized, user chosen analysis of switch and/or network performance at the switch. The disclosed network switches, methods and script sandboxing instructions efficiently allocate switch resources to provide such customized user chosen analysis of switch and/or network performance.

The disclosed network switches, methods and script sandboxing instructions allow users to upload customized scripts to a network switch to view or analyze selected pieces of switch data stored on the switch. The disclosed network switches, methods and script sandboxing instructions sandbox the different portions of each script to limit the extent of resources that may be consumed by each script and each portion of each script. The network switches, methods and script sandboxing instructions allocate the different sandboxes to multiple different threads carried out by the cores on the switch, in parallel, to more efficiently carry out such performance analysis.

For purposes of this disclosure, a “sandbox” refers to a virtualized container for providing a controlled environment for carrying out the execution of a program. A sandbox may be implemented by executing encoded portions of a script or an encoded script in a restricted virtual operating system environment, controlling the resources, such as file descriptors, memory, filesystem space and the like, that a particular process may utilize. In many of the described examples, portions of a network analytical script are encoded to a sandbox. The sandbox hosts a compiler that executes the encoded script. For example, in some implementations, execution of the encoded script may result in the configuration or establishment of an agent that monitors switch data or may result in various actions with respect to switch resources that are triggered or activated in response to the agent identifying the satisfaction of at least one threshold or condition by the monitored switch data. The “instantiation” of a sandbox comprises the creation of a sandbox and the encoding of a script or script portion to the sandbox, or the encoded script is ready for being in an and him and compiled and executed by the sandbox.

In some implementations, the sandboxes are created or instantiated on the different threads in a just in time fashion. In particular, the execution and completion of sandboxes on each of the threads is monitored. Sandboxes are created or instantiated based upon the monitored state of the sandboxes on the threads. For example, in one implementation, a controller or sandbox manager may limit the number of sandboxes on each thread, wherein the creation or addition of new sandboxes to the thread is delayed until the sandbox manager determines that a sandbox being executed on the thread has just been completed or has been terminated.

In some implementations, different sandboxes are differently instantiated on different particular threads based upon the type of script portion to be executed by the different sandboxes. In other words, sandboxes containing particular types of script portions may be given a higher weight or higher priority with respect to sandboxes containing other types of script portions. In one implementation, different action or call back script portions may be assigned different weightings or priorities, wherein the creation of sandboxes for the different action or call back script portions occurs in an order based upon the weightings or priorities.

Disclosed herein is an example network switch that may include a memory to store monitored switch data, at least one processing core to execute threads and a sandbox manager. The sandbox manager is to receive a network analytics script for analyzing the monitored switch data. The sandbox manager further performs multi-threaded sandboxing of the network analytics scripts by creating different sandboxes on different particular threads to execute the different portions of the network analytics script.

Disclosed herein is an example network switch performance analysis method. The method includes receiving, on a network switch, a network analytics script for analyzing stored monitored switch data. The method further includes instantiating sandboxes on different threads to execute different portions of the network analytics script.

Disclosed herein is an example set of script sandboxing instructions contained on a non-transitory computer-readable medium. The script sandboxing instructions include script loading instructions and sandbox instantiation instructions. The script loading instructions direct a processor to receive or upload network analytics scripts on a network switch. The sandbox instantiation instructions direct a processor to instantiate a number of sandboxes on different threads of the network switch to execute different portions of the different network analytics scripts in parallel.

FIG. 1 is a block diagram schematically illustrating portions of an example network switch 20. Network switch 20 provides resource efficient user chosen network switch performance analysis. Network switch 20 allows users to upload customized scripts to view or analyze selected pieces of routing or other switch resource performance data stored on the switch 20. Network switch 20 sandboxes different portions of the scripts to limit the extent of resources that may be consumed by each portion of the script. Network switch 20 allocates the different sandboxes to multiple different threads carried out by the cores on the switch, in parallel, to more efficiently carry out such routing and/or resource usage analysis. Network switch 20 comprises switch networking data memory 24, at least one processing core 28 and sandbox manager 40.

Switch data memory 24 comprises a non-transitory computer-readable medium storing switch data gathered by switch 20 during the routing of communications by switch 20. Such data is gathered by monitoring of the actual resources used or consumed by network switch 20 rather than the reading of the specific contents of the communication/packets being routed. Networking performance data may pertain to what port of the switch received a packet, how a packet was routed through the switch and what port of the switch externally transmitted the packet, each of which being stored after a routing path for the packet through the switch had been determined. Some examples of resources of switch 20 for which data is stored in memory 24 include switch CPU/memory performance, temperature, fan speed, packet queue depth, interface lag and the like. Such switch data may comprise an integer, float, string, enums or list type of data structure that is stored within the network switch. Such data may be retrieved for viewing and/or retrieved for use as input to further performance calculations. Such data or results derived from such data may be compared against thresholds to trigger various actions or responses by the network switch.

Processing cores 28 comprise individual or independent processors or processing units which read instructions to perform specific actions. Each of the processing cores 28 may include threads on which lines of command are delivered and processed. Each of the cores 28 may work on at least one thread or multiple threads simultaneously or in parallel. As schematically represented by FIG. 1, the processing core(s) 28 run or execute threads 30-1 to 30-2 (collectively referred to as threads 30).

Sandbox manager 40 comprises a processing unit on the network switch 20 that carries out instructions to (1) receive a network analytics script 42 for analyzing the monitored switch data contained in memory 24 and (2) sandbox and multi-thread different portions of the script amongst different sandboxes on different particular threads 30 to execute the different portions of the network analytics on the different threads. As shown by broken lines, the example network analytics script or script package 42 received by network switch 20 comprises multiple portions, portion 1 (p1) 44-1 and portion 2 (p2) 44-2 (collectively referred to as script portions 44). In some implementations, an example network analytics script package 42 may contain three portions, a script portion, an agent portion and a callback portion as described below.

As further shown by FIG. 1, in some implementations, sandbox manager 40 instantiates different sandboxes 46-1, 46-2 (collectively referred to as sandboxes 46) for different script portions 44 on different threads 30 for execution by the different sandboxes 46 on the different threads 30 in parallel. In some implementations, sandbox manager 40 may be part of an overall are larger networks analytics engine contained on the network switch 20. Although processing cores 28 are illustrated with two threads 30, it should be appreciated that processing cores 28 may include additional threads, depending upon the number of cores and the individual properties of such cores.

Because sandbox manager 40 sandboxes the script portions 44, the amount of resources accessed or consumed by each script portion, and by each overall script package 42, is limited based upon the content or architecture of the sandbox. As a result, sandbox manager 40 inhibits the execution of user inputted script packages that are not authorized, or appropriate or that might otherwise consume an unduly large amount of switch resources. Because sandbox manager 40 allocates the different sandboxes amongst multiple threads in parallel, the sandboxes and the contained script portions may be more efficiently processed to more efficiently extract data from memory 24 for display and/or further processing/calculations.

In some implementations, the sandboxes 46 are created or instantiated on the different threads 30 in a just in time fashion. In particular, the execution and completion of sandboxes on each of the threads 30 is monitored. Sandboxes are created or instantiated based upon the monitored state of the sandboxes on the threads. For example, in one implementation, sandbox manager 40 may limit the number of sandboxes 46 on each of threads 30, wherein the creation new sandboxes 44 or the addition of new sandboxes 44 to the thread is delayed until the sandbox manager 40 determines that a script portion being executed by a particular sandbox on the thread has just been completed or terminated.

In some implementations, different sandboxes 46 are differently instantiated on different particular threads based upon the type of the network analytics scripts to be executed by the different sandboxes. In other words, sandboxes containing particular types of script portions may be given a higher weight or higher priority with respect to sandboxes containing other types of script portions. In one implementation, different action or call back script portions may be assigned different weightings or priorities, wherein the creation of sandboxes for the different action or call back script portions occurs in an order based upon the weightings or priorities.

FIG. 2 is a flow diagram of an example network switch analytics method 100. Method 100 facilitates customized, user chosen analysis of routing or resource usage performance of a network switch. Method 100 efficiently allocates switch resources to provide such customized user chosen analysis of routing or resource usage performance.

Method 100 allows users to upload customized scripts to a network switch to view or analyze selected pieces of routing and/or resource usage performance data stored on the switch. Method 100 sandboxes the scripts to limit the extent of resources that may be consumed by each script portion or script package. Method 100 selectively and controllably allocates the different sandboxes to multiple different threads carried out by the cores on the switch, in parallel, to more efficiently carry out such routing or resource usage analysis. Although method 100 is described in the context of being carried out by network switch 20, it should be appreciated that method 100 may likewise be carried out with any of the following described network switches or with other similar network switches.

As indicated by block 104, a network analytics script (sometimes referred to as a shell script) for analyzing stored monitored switch data is received on a network switch. In some implementations, the network analytic script or script package may be manually keyed in by a user. In some implementations, the network analytics script package may be entered by the user with the assistance of various graphical user interfaces provided by an application or webpage. Such script packages may include different portions such as a script uploading portion, an agent portion and an action or call back script portion.

An analytical script or script package is a programmable script in any computer language that will provide the following information Monitor, Condition and Action Objects. A script uploading portion of the script comprises a portion of the script that requests the uploading of identification or manifest information for an agent script portion or a call back script portion.

The agent portion of the script includes the monitor and condition objects. The Monitor object gives details about what resource/data is to be monitored on the network switch or network. Some examples of resources are switch CPU/memory performance, temperature, fan speed, packet queue depth, interface lag etc. The Condition object has the queries that determine if any of these data sources are exceeding or below the threshold mentioned in the script. The Action object specifies what action should be taken when the condition query is met. The Analytical Engine on the switch supports this form of script. Agent script portions turn on or trigger the ongoing retrieval or ongoing monitoring of particular switch networking data in memory 24. Agent script portions further compare the retrieved switch data to thresholds (the condition object) to potentially trigger activation of a current or sleeping call back script portion of the script package.

Action or call back script portions cause network switch 20 to carry out particular actions, adjustments or modifications based at least in part upon the switch networking data retrieved from memory 24. For example, a callback script may direct network switch 20 to either run a command on the switch, collect logs, send an email or publish a ticket on a third-party website.

As indicated by block 108, different sandboxes 44 for the different portions of the network analytics script 42 are instantiated or created on different threads 30 to execute the different script portions in parallel.

In some implementations, the sandboxes 44 are created or instantiated on the different threads 30 in a just in time fashion. In particular, the execution and completion of sandboxes on each of the threads 30 is monitored. Sandboxes are created or instantiated based upon the monitored state of the sandboxes in their contained script portions on the threads. For example, in one implementation, sandbox manager 40 may limit the number of sandboxes 44 on each of threads 30, wherein the creation or addition of new sandboxes 44 to the thread is delayed until the sandbox manager 40 determines that a sandbox being executed on the thread has just been completed or terminated.

In some implementations, different sandboxes 44 are differently instantiated on different particular threads based upon the type of the script portions to be executed by the different sandboxes. In other words, sandboxes containing a particular type of script portion, such as a (a) script uploading, (b) agent or (c) call back types of script portions, may be given a higher weight or higher priority with respect to sandboxes containing other types of scripts. In one implementation, different action or call back script portions may be assigned different weightings or priorities, wherein the creation of sandboxes for the different action or call back script portions occurs in an order based upon the weightings or priorities.

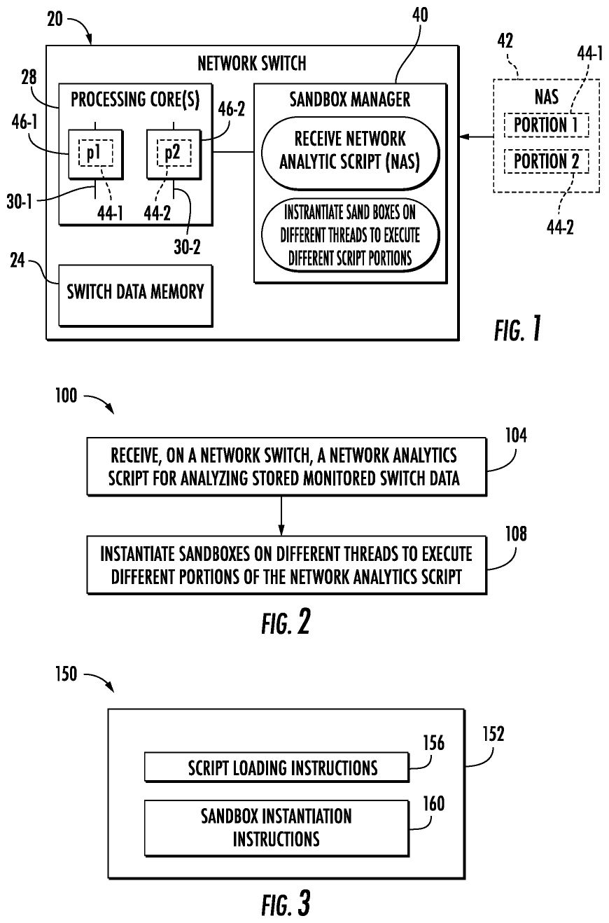

FIG. 3 is a block diagram schematically illustrating portions of a non-transitory computer-readable medium 150 that contains sandboxing instructions 152. Such sandboxing instructions 152 comprise script loading instructions 156 and sandbox instantiation instructions 160. The script loading instructions 156 direct a processor to receive or upload network analytics scripts on a network switch, such as network switch 20. The sandbox instantiation instructions 160 direct a processor to instantiate a number of sandboxes on different threads of the network switch to execute different portions of each of the network analytics scripts in parallel.

In some implementations, the sandbox instantiation instructions 160 direct the creation of different sandboxes on the different threads in a just in time fashion. In particular, the execution and completion of sandboxes on each of the threads 30 is monitored. Sandboxes are created or instantiated based upon the monitored state of the sandboxes on the threads. For example, in one implementation, sandbox instantiation instructions 160 may cause a processor to limit the number of sandboxes 44 on each of threads 30, wherein the creation or addition of new sandboxes 44 to the thread is delayed until the sandbox manager 40 determines that a sandbox being executed on the thread has just been completed or terminated.

In some implementations, sandbox instantiation instructions 160 cause a processor to differently instantiate sandboxes on different particular threads based upon the type of the network analytics scripts to be executed by the different sandboxes. In other words, sandboxes containing particular type of script portions (a script uploading portion, and agent portion or a callback portion) may be given a higher weight or higher priority with respect to sandboxes containing another type of script portion. In one implementation, different action or call back script portions may be assigned different weightings or priorities, wherein the creation of sandboxes for the different action or call back script portions occurs in an order based upon the weightings or priorities.

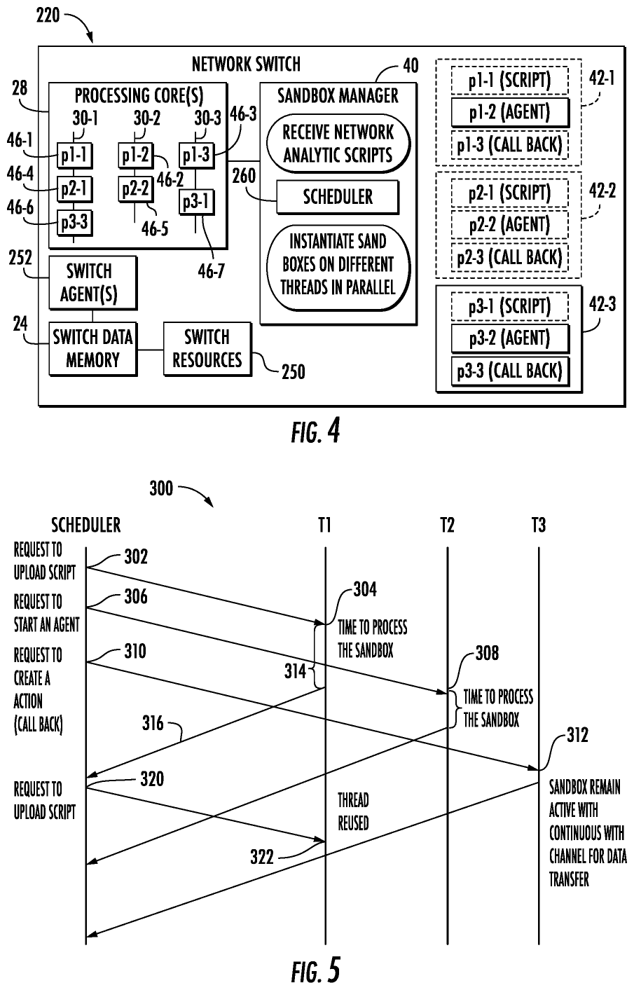

FIG. 4 is a block diagram schematically illustrating portions of an example network switch 220. As with network switch 20, network switch 220 provides resource efficient user chosen network switch performance analysis. Network switch 220 allows users to upload customized scripts to view or analyze selected pieces of routing and sets or resource usage performance data stored on the switch 20. Network switch 220 sandboxes different portions of the scripts to limit the extent of resources that may be consumed by each script portion. Network switch 220 allocates the different sandboxes to multiple different threads carried out by the cores on the switch, in parallel, to more efficiently carry out such routing performance analysis. Network switch 220 is similar network switch 20 described above except that switch 220 is additionally illustrated as comprising switch resources 250, switch agents 252, and scheduler 260. Those remaining components of network switch 220 which correspond to components of network switch 20 are numbered similarly.

Switch resources 250 (schematically illustrated) represents various resources of switch 220 such as fans, memories, power supplies, and the like. In the summer switch resources 250 may have performance data that is stored in an ongoing or periodic fashion in switch data memory 24. Such data within memory 24 may be accessed by switch monitors 252.

Switch agents 252 comprises modules of code that are configured or created by agent scripts for directing the cores 28 to monitor changes to data in switch data memory 24. Once an agent script has been executed in its associated sandbox, the created or configured switch agent 252 continues to monitor the selected data until the particular switch agent 252 is turned off or inactivated by external intervention either using a flag to set using Remote connection such as REST/HTTP or clicking the disable button on a web interface.

In the example illustrated, the processing of sandboxes containing call back scripts is slightly different than the processing of sandboxes containing encoded script uploading or encoded agent script portions. Upon the instantiation of a sandbox on a thread containing a script uploading script or an agent script portion, such sandboxes are executed in order with other sandboxes on the thread. In contrast, those instantiated sandboxes containing encoded call back script portions are maintained in a “sleep state” until activated or until being awoken by the associated agent 252 having retrieved monitored data from memory 24 that satisfies a predetermined threshold or condition. In the “sleep state”, the inactive call back sandboxes simply reside on the thread without being executed. Upon being activated, the encoded call back script portion is compiled and executed by the call back sandbox.

In the example illustrated, the call back sandboxes 46-6 and 46-7 remain in a sleep state until activated by associated agents 252 (created by the execution of the encoded agent script portions p1-2 and p2-2, respectively) in response to thresholds being satisfied by the switch data being monitored by the switch agents 252. Once a call back sandbox has been activated, the execution of encoded call back script portion (the action) in the respective call back sandbox (which contains compilers for executing the encoded script) cause the output of signals by cores 28 to change the state of switch resources 250.

For example, the temperature of a network switch may be stored in memory 24. An agent script portion of a user loaded script package may create or configure an agent 252 to retrieve the stored and monitored switch temperature (the monitor object). The established agent 252 may continuously or periodically compare the retrieved switch temperature against a threshold (the condition object. Upon the threshold being satisfied, the associated action object in the associated and compiled call back script portion may be activated. The call back script portion in its call back sandbox may cause the cores 28 to output signals changing a state of the switch resources 250, such as changing the speed of a switch fan. After such actions have been completed by execution of the action/call back script in the sandbox, the associated action/call back script in its sandbox may be actuated to a sleep state, readied for being activated again by the previously established and associated agent 252 once again determining that the threshold/condition object has once again been satisfied.

Scheduler 260 comprises code that directs a processor of sandbox manager 40 to control the timing at which different sandboxes containing different script portions are instantiated on different threads. In one implementation, scheduler 260 directs the processor of sandbox manager 42 monitor the state of the various sandboxes currently being carried out executed on the different threads. Based upon the monitored state of the different sandboxes being executed, scheduler 260 schedules the instantiation of new sandboxes on the different threads.

In some implementations, scheduler 260 creates or instantiates different sandboxes 44 on the different threads 30 in a just in time fashion. In particular, the execution and completion of sandboxes on each of the threads 30 is monitored. Sandboxes 44 are created or instantiated based upon the monitored state of the sandboxes on the threads. For example, in one implementation, scheduler 260 may limit the number of sandboxes 44 on each of threads 30, wherein the creation or addition of new sandboxes 44 to the thread is delayed until the sandbox manager 40 determines that a sandbox being executed on the thread has just been completed or terminated.

In some implementations, scheduler 260 differently instantiates different sandboxes 44 on different particular threads based upon the type of the network analytics scripts to be executed by the different sandboxes. In other words, sandboxes containing particular types of scripts may be given a higher weight or higher priority with respect to sandboxes containing other types of scripts. In one implementation, different action or call back scripts may be assigned different weightings or priorities, wherein the creation of sandboxes for the different action or call back scripts occurs in an order based upon the weightings or priorities.

In the illustrated example, switch 220 is illustrated as having received three scripts or script packages 42-1, 42-2 and 42-3. Scheduler 250 has instantiated various sandboxes 46 on different threads 30-1, 30-2 and 30-3 of processing course 28. Each of the sandboxes 46 contain a different encoded script portion of the script packages 42. In the example illustrated, scheduler 260 as directed sandbox manager 40 to create sandboxes 46-1 to 46-7 in the corresponding order. In the example illustrated, script portions p1-1 (script portion of script package 42-1), p2-1 (agent portion of script package 42-1) and p2-3 the call back portion of script package 42-2) are being executed in sandboxes 46-1, 4 to 6-4 and 46-6, respectively on thread 30-1. The encoded script portions p1-2 and p2-2 are being executed by instantiated sandboxes 46-2 and 46-5, respectively on thread 30-2. The encoded script portions 46-3 and 46-7 are being executed by instantiated sandboxes 46-3 and 46-7, respectively, on thread 30-3. As indicated by solid lines, portions 93-2 and 93-3 of script package 42-3 are not yet encoded, but are queued for the encoding in subsequently instantiated sandboxes for their execution.

FIG. 5 is a diagram illustrating one example of the scheduling 300 of sandboxes containing portions of analytic scripts on different threads in a network switch, such as network switch 220, by a scheduler, such as scheduler 260. At time 302, scheduler 260 receives a script uploading script, a request to upload subsequent scripts. At time 304, scheduler 260 instantiates a sandbox containing the script uploading script on thread T1. At time 306, scheduler 260 receives an agent script portion, a request to start an agent. At time 308, scheduler 260 instantiates the agent script portion on thread T2 for processing in parallel with the script uploading script which began at time 304. At time 310, scheduler 260 receives an action or “callback” script portion, whereby scheduler 260 instantiates a sandbox containing the call back script portion at time 312 on thread T3.

During time 314, the script uploading script portion encoded in a sandbox at time 304 is executed and completed, wherein the completion of the encoded script uploading script is communicated to scheduler 260 as indicated by arrow 316. Based upon receiving notice or determining that the uploaded script portion has been completed, scheduler 260, which received a second script uploading script portion at time 320, instantiates a new sandbox on thread T1 at time 322 by encoding second script uploading script portion in the new sandbox. At such time, the thread T1 is reused for a new sandbox containing a different encoded script portion.

As shown by FIG. 5, this just in time creation or instantiation of sandboxes for script portions continues in a similar fashion upon the completion of the script portions being executed on the threads T2 and T3. For example, upon determining that the script contained in the agent sandbox instantiated at time 308 has been completed, scheduler 260 may then instantiate a new sandbox on thread T2, such as a sandbox containing an agent script or a sandbox containing a different script. Likewise, upon determining that the sandbox containing the script portion instantiated at time 312 has been completed, scheduler 260 may instantiate a new sandbox containing a different script portion on thread T3. In some implementations, completion of a script portion, such as a script uploading script portion or an agent script portion, in a sandbox results in the sandbox being terminated. In some implementations, though sandbox containing action or call back script portion remain active, continuing to receive network performance data as initiated by the earlier agent script and continuing to trigger actions by the network switch in response to or based upon a comparison of the network and/or resource usage performance data to certain predetermined thresholds or criteria.

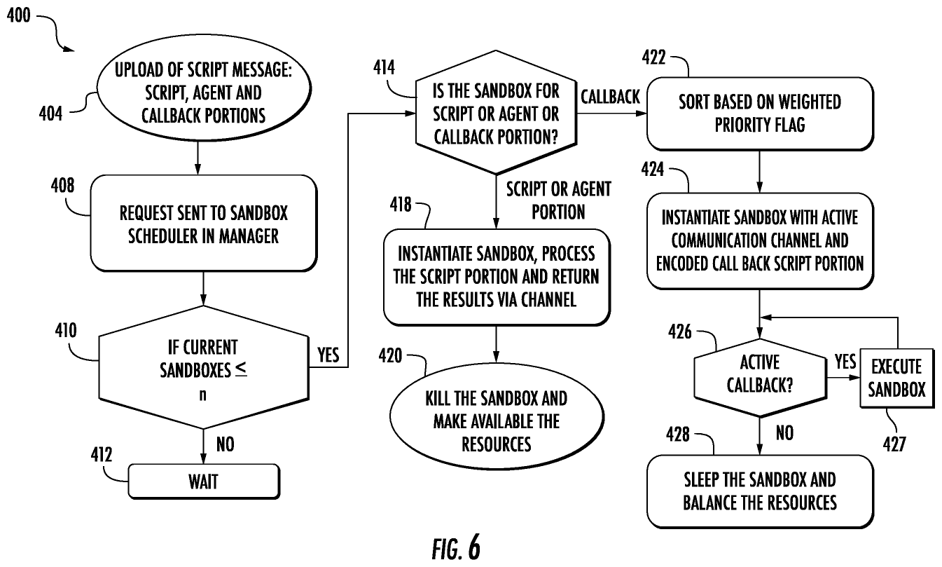

FIG. 6 is a flow diagram illustrating an example network analytic script sandbox scheduling method 400 that may be carried out by scheduler 260. Method 400 schedules the creation or instantiation of different sandboxes containing different scripts on different particular threads based upon the type of the network analytics scripts to be executed by the different sandboxes. In other words, sandboxes containing particular types of scripts may be given a higher weight or higher priority with respect to sandboxes containing other types of scripts. In one implementation, different action or call back scripts may be assigned different weightings or priorities, wherein the creation of sandboxes for the different action or call back scripts occurs in an order based upon the weightings or priorities.

As indicated by block 404, a network switch receives a script package via user input. The script package may include different portion such as a script uploading portion, an agent script portion and a callback script portion. As indicated by block 408 each of the script uploading portion, the agent portion and the call back portion of the script package are sequentially handled by the scheduler 260. As indicated by decision block 410, for each of the script portions being handled in succession, the scheduler 260 compares the current number of active sandboxes on the existing threads 30 against a predetermined maximum number of sandboxes n. The predetermined maximum number of sandboxes n represents a maximum number of sandboxes that may be concurrently executed on the threads in parallel without using too much of the switch resources that might otherwise render other switching features or functions unavailable for short durations and which might otherwise be detrimental to the routing carried out by the switch.

In one implementation in which sandboxes are concurrently executed in parallel on multiple threads, the predetermined maximum number of sandboxes n is based upon the number of cores 28 and the number of threads 30. For example, in one implementation, the predetermined maximum number of sandboxes n is the number of threads times the number of cores. The maximum size of a queue for action/callback switches is 10 times the number of threads times the number of cores.

As indicated by block 412, in response to the current number sandboxes not being less than the maximum number of sandboxes allowed, the creation or instantiation of new sandboxes delayed. Alternatively, as indicated by block 414, in response to the current number of sandboxes not exceeding the maximum number of sandboxes allowed, scheduler 250 proceeds by determining the script type that is to be contained in the next instantiated sandbox.

As indicated by block 418, in response to the script being a script uploading script portion or an agent script portion, scheduler 250 instantiates a sandbox to contain the script, to process the script and to return results via a channel. Such instantiation of the sandbox and processing the script may be carried out in a just-in-time fashion as described above with respect to FIG. 5. As indicated by block 420, upon completion of the processing of the script in the sandbox and the output of results, the sandbox manager kills the sandbox and makes the switch resources available again, making the particular thread available for receiving a new sandbox containing a different script portion.

As indicated by block 422, in response to the script portion comprising an action or “callback” script portion, scheduler 250 sorts and queues the current script portion with respect to other previously received and queued call back script portions based upon their weighted priority as indicated by weighted priority flags attached to such scripts by the user who inputted the script. As indicated by block 424, scheduler 250 instantiates a sandbox for the highest priority callback script portion in queue, creating an active sandbox with an active communication channel for the transmission of actions or changes that are triggered by the switch networking data received by the previously created agent (created by a previous agent script portion executed in a prior sandbox).

As indicated by decision block 426, an active state of the callback sandbox is continuously monitored. The sandbox containing the call back script remains active so long as the switch agents 252 is also active, continuing to supply the monitored and stored switch networking data to the call back script being executed in the sandbox. As indicated by block 427, the activation of the callback sandbox resulting from the triggering of her condition as determined by the associated agent 252, results in the callback sandbox being executed. As indicated by block 428, upon the previously created sandbox containing the callback portion no longer being active, no longer being triggered by the switch agent 252, the sandbox containing the encoded callback script is not terminated, but is placed in a sleep state, ready for use or activation again upon execution of another agent script that once again activates an agent or switch agents 252 for supplying the callback script with switch data. Such a sleep state preserves resources in that reencoding of the generally more complex and lengthy call back script is avoided. While the sandbox containing the callback script portion is in a sleep state, the resources/thread previously consumed by the active sandbox executing the active callback portion are made available for executing other sandboxes executing of the script portions.

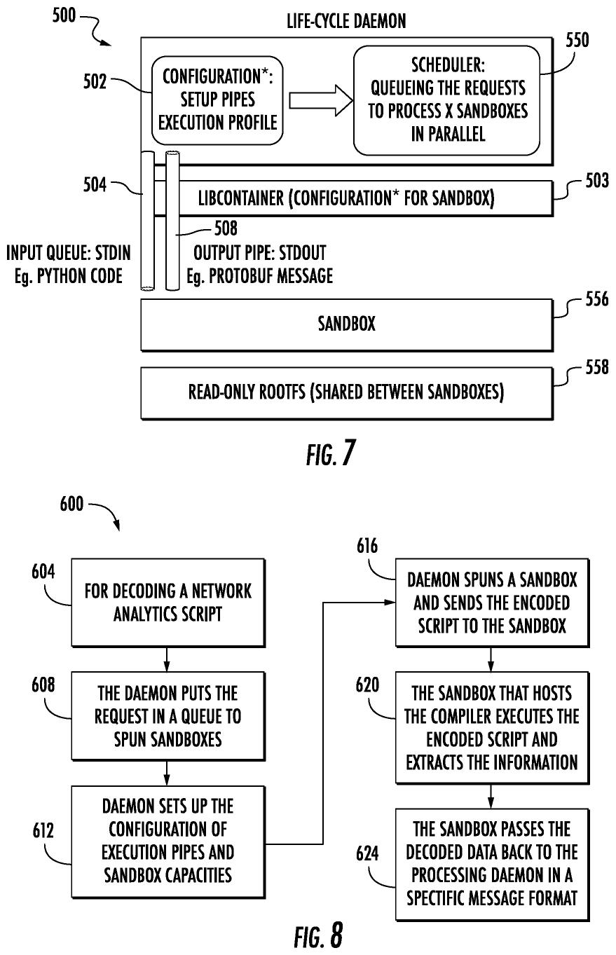

FIG. 7 is a block diagram illustrating portions of an example sandbox manager in the form of a life-cycle Daemon 500 that may be provided as part of a network analytics engine on a network switch. As shown by FIG. 7, the daemon 500 comprises a configuration module 502, code that directs a processor to establish the sandbox 556. In one implementation, the configuration module 552 uses a predefined stored set of configuration parameters when establishing sandbox 556, such as the set of parameters 503 for a Lib container. In other implementations, the sandboxes may have other configurations.

In addition to defining the architecture of the sandboxes, configuration module 502 of daemon 500 further establishes or sets up the channels or pipes 504, 508. Pipe 504 encodes a script portion into sandbox 556. In one implementation, pipe 504 may constitute an input queue or Stdin 504 for the instantiation of sandbox 556, the encoding of the script portion onto the sandbox, on a particular thread of the cores. Output pipe 508, such as a Stdout, serves to output, in a proper format, the results from the execution of the encoded script portion by the sandbox 556. The output pipe 508 may transmit the results of the executed script, such as in the form of a protocol buffer message.

Daemon 500 further comprises a scheduler 550 that queues the script portions yet to be encoded and instantiated as sandboxes based upon the predetermined maximum number of sandboxes that may be executed in parallel by the cores of the switch. Scheduler 550 is similar to scheduler 250 described above. Scheduler 550 may implement a just-in-time instantiation of sandboxes on different threads such as described above with respect to the example illustrated in FIG. 5. In some implementations, scheduler 550 may carry out method 400 described above.

As further shown by FIG. 7, the sandbox 556 shares read-only Rootfs by 58 during execution of the script portion. As described above, execution of an encoded agent script portion by sandbox 556 creates the switch agent 252 (shown and described with respect to FIG. 4) to retrieve and monitor data from a switch data memory comes such as switch data memory 24 shown in FIG. 4. Execution of an encoded callback script portion by sandbox 556 causes the output of signals affecting switch resources, the output of an alert and/or the display of monitored data. In circumstances where sandbox 556 contains an encoded callback script portion, sandbox 556 may be, at times, in a sleep state until activated in response to a corresponding agent 252 having a threshold or condition satisfied by the monitored switch data.

FIG. 8 is a flow diagram of an example method 600 for processing a portion of a script package by daemon 500. As indicated by block 604, daemon 500 receives a request for decoding a network analytics script. As indicated by block 608, daemon 500 places the portion of the script package in a queue being encoded in a sandbox. As indicated by block 612, configuration module 502 of daemon 500 sets up the configuration for sandbox 556 and for the execution pipes 504, 508.

As indicated by block 616, daemon 500 may instantiate a sandbox 556, wherein the queued script portion is encoded by pipe 504 into the sandbox 556. As discussed above, the instantiation of the sandbox may be triggered by scheduler 550. The schedule instantiation of a sandbox on a particular thread and the loading of the sandbox with the queued script portion may occur in a just-in-time fashion as described above with respect to FIG. 5 or may be based upon a prioritization scheme as discussed above with respect to method 400 based upon the type of script portion to be loaded into the sandbox.

As indicated by block 620, the created sandbox may host a compiler that executes the encoded script and extracts the information from the switch networking data memory, such as memory 24 described above. As indicated by block 624, the sandbox passes the data extracted data from the memory 24, through pipe 508 which decodes the results and transmits the results back to a processing daemon (not shown) which presents the extracted information in a specific message format.

Although the present disclosure has been described with reference to example implementations, workers skilled in the art will recognize that changes may be made in form and detail without departing from the subject matter of the current disclosure. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A network switch comprising:
a memory to store monitored switch data;
at least one processing core to execute threads;
a sandbox manager to:
receive a network analytics script for accessing the monitored switch data; and
perform multi-threaded sandboxing of the network analytics script by creating different sandboxes on different threads to execute different portions of the network analytics script.

2. The network switch of claim 1, wherein the sandbox manager comprises a scheduler to monitor execution of a particular first sandbox on a particular thread and to instantiate a second sandbox of the network analytic script or another network analytics script on the particular thread based upon a state of the execution of the particular first sandbox.

3. The network switch of claim 2, wherein the sandbox manager is to balance sandbox load across the threads.

4. The network switch of claim 1, wherein the sandbox manager is to instantiate a total number of sandboxes on the threads less than a maximum number of sandboxes based upon a number of cores and a number of threads executed by the cores.

5. The network switch of claim 1, wherein the sandbox manager is to differently instantiate the different sandboxes on different threads based upon different types of script portions to be executed by the different sandboxes.

6. The network switch of claim 1, wherein the sandbox manager is to compare priority weights assigned to different call back portions of different network analytics scripts and wherein the sandbox manager is to instantiate different sandboxes for the different call back portions in an order based upon the comparison.

7. A method comprising:
receiving, on a network switch, a network analytics script for analyzing stored monitored switch data;
instantiating sandboxes on different threads to execute different portions of the network analytics script.

8. The method of claim 7 further comprising:
monitoring, on the network switch, a state of a particular first sandbox on a particular thread; and
instantiating a second sandbox on the particular thread based upon a state of the execution of the particular first sandbox.

9. The method of claim 7 further comprising:
monitoring, on the network switch, execution of a particular first sandbox on a particular thread; and
instantiating a second sandbox on the particular thread in response to completion of the particular first sandbox on the particular thread.

10. The method of claim 9, wherein the instantiation of the second sandbox is to balance sandbox load across the threads.

11. The method of claim 7, wherein a total number of sandboxes instantiated on the threads is controlled so as to be less than a maximum number of sandboxes based upon a number of cores and a number of threads executed by the cores.

12. The method of claim 7, wherein the different sandboxes are differently instantiated on different particular threads based upon different types of script portions to be executed by the different sandboxes.

13. The method of claim 7 further comprising:
comparing priority weights assigned to different call back portions of different network analytics scripts; and
instantiating different sandboxes for the different call portions in an order based upon the comparison.

14. The method of claim 12 further comprising assigning a priority weight to a call back portion of network analytics script based upon an alert triggering.

15. A non-transitory computer-readable medium containing script sandboxing instructions to direct a processor, the instructions comprising:
script loading instructions to receive network analytics scripts on a network switch;
sandbox instantiation instructions to instantiate a number of sandboxes on different threads of the network switch to execute different portions of the network analytics scripts in parallel.

16. The medium of claim 15, wherein the instructions further comprise scheduling instructions to monitor execution of the different portions on the different threads and to instantiate second sandboxes on the different threads based upon a state of the execution of the different portions.

17. The medium of claim 16, wherein the scheduling instructions are to balance sandbox load across the threads.

18. The medium of claim 15, wherein the instantiation instructions are to direct the processor to limit a total number of sandboxes instantiated on the threads to a number less than a maximum number of sandboxes based upon a number of cores and a number of threads executed by the cores.

19. The medium of claim 15, wherein the instantiation instructions are to direct the processor to differently instantiate the different sandboxes on different threads based upon different types of script portions to be executed by the different sandboxes.

20. The medium of claim 15, wherein the instantiation instructions are to direct the processor to compare priority weights assigned to different call back portions of different analytics scripts and wherein the sandbox manager is to instantiate different sandboxes for the different call back portions in an order based upon the comparison.
